(19) United States
(12) Patent Application Publication
(10) Pub. No.: US 2018/0357459 A1
(43) Pub. Date: Dec. 13, 2018

(54) OPTICAL FINGERPRINT MODULE

(71) Applicant: Shanghai Oxi Technology Co., Ltd, Shanghai (CN)

(72) Inventors: Yan LING, Shanghai (CN); Hong ZHU, Shanghai (CN)

(21) Appl. No.: 15/761,729

(22) PCT Filed: Feb. 15, 2017
(86) PCT No.: PCT/CN2017/073619

§ 371 Date: Mar. 20, 2018

(30) Foreign Application Priority Data
Aug. 31, 2016 (CN) 201610785619.7

(51) Int. Cl. G06K 9/00; G06F 3/044

(52) U.S. Cl. CPC G06K 9/0004; G06F 3/044

(57) ABSTRACT

An optical fingerprint module includes an optical fingerprint sensor, the optical fingerprint sensor has a non-opaque substrate and a device layer disposed on the surface of the non-opaque substrate, the device layer includes a pixel area which includes a plurality of pixels, each of the plurality of pixels includes a light transmitting area and a light-blocked area, the light transmitting area includes a photosensitive device, and the light transmitting area enabling lights to transmit through the pixel area of the device layer a protection layer is disposed above the optical fingerprint sensor: a backlight source is disposed below the optical fingerprint sensor, and the angle between the light emitting from the backlight source and the surface of the pixel area is acute: a touch sensing layer is disposed between the protective layer and the optical fingerprint sensor. The optical fingerprint module structure, the performance, and the feature are improved.

### CROSS-REFERENCE TO RELATED APPLICATIONS

This application claims the benefit of priority to Chinese Patent Application No. 201610785619.7, filed on Aug. 31, 2016, and entitled “Optical Fingerpaint Module”, the entire disclosure of which is incorporated herein by reference.

### TECHNICAL FIELD

The present invention relates to the field of optical fingerprint recognition, and more particularly, to an optical fingerprint module.

### BACKGROUND

Fingerprint recognition technology is used to realize identification by capturing fingerprint images of a person using optical fingerprint sensors (or modules), and then determine whether the fingerprint image information matches that stored in the system before. Due to its easy to use, and the uniqueness of the fingerprint, the fingerprint recognition technology has been widely applied in various fields, such as security inspection field including public security bureau, customs and the like, building entrance guard field, as well as consumption goods field including personal computers, mobile phones and the like. The fingerprint recognition technology includes optical imaging, capacitance imaging, ultrasound imaging and the like, among which the optical fingerprint recognition technology is advantageous in the image quality and device cost.

As shown in FIG. 1, the existing optical fingerprint module includes a backlight source 110, an optical fingerprint sensor 120, a protective layer 130, and a shell (not shown). When the optical fingerprint module is capturing a fingerprint image, a person's finger 140 is placed on the protective layer 130; the output light 111 of the backlight source 110 (each of the upward arrows in FIG. 1 indicates the output light 111, as enclosed in a dotted line frame) pass through the optical fingerprint sensor 120 and the protective layer 130, and is reflected and transmitted at the contact interface between the human finger 140 and the protective layer 130; The reflected light 112 (each of the downward arrows in FIG. 1 represents the reflected light 112, as enclosed in a dotted line frame) passes through the protective layer 130, and illuminates on the optical fingerprint sensor 120; and the optical fingerprint sensor 120 performs a photoelectric conversion and signal processing by its inner circuit (not shown) to realize fingerprint image capturing. Since the characteristics of the contact interface between the human finger 140 and the protective layer 130 reflects the fingerprint feature of the finger, and the characteristics of the contact interface directly affect the characteristics of the reflected light 112, therefore, the image acquired by the optical fingerprint sensor 120 shows the characteristics of the fingerprint of the human.

More information on the optical fingerprint module can refer to the Chinese utility model patent with publication number CN203405831U.

However, there is a need for an improvement for the structure and the performance of the present optical fingerprint module.

### SUMMARY

Embodiments of the present disclosure provide an optical fingerprint module with optimized structure to improve the performance and feature of the optical fingerprint module.

The present disclosure provides an optical fingerprint module, including: an optical fingerprint sensor including a non-opaque substrate and a device layer on the surface of the non-opaque substrate, wherein the device layer includes a pixel area, the pixel area includes a plurality of pixels, each of the pixels includes a light transmitting area and a light-blocked area, and the light-blocked area includes a photosensitive device formed therein, and the light transmitting area allows light to pass through the pixel area of the device layer; a protective layer disposed above the optical fingerprint sensor; a backlight source disposed below the optical fingerprint sensor, where an angle between the light emitting from the backlight source and the surface of the pixel area is acute; and a touch sensing layer disposed between the protective layer and the optical fingerprint sensor.

In some embodiments, the optical fingerprint module may further include a non opaque layer between the protective layer and the optical fingerprint sensor; where the touch sensing layer is disposed between the protective layer and the optical fingerprint sensor.

In some embodiments, the touch sensing layer may be disposed below a lower surface of the protective layer.

In some embodiments, the non opaque layer may include a glass layer, a plastic layer, or an optical adhesive layer.

In some embodiments, the touch sensing layer may be disposed above an upper surface of the non opaque layer.

In some embodiments, the thickness of the non opaque layer may be less than 1.5 mm, and the thickness of the non opaque layer may be more than 0.01 mm.

In some embodiments, the backlight source may include at least one LED, the light of the LED includes near ultraviolet light, violet light, blue light, green Light, yellow light, red light, near infrared light, or white light; or the backlight source may include two or more LEDs symmetrically disposed below the optical fingerprint sensor, the light of the LED may include near ultraviolet light, purple light, blue light, green light, yellow light, red light, near infrared light, or white light.

In some embodiments, a focusing lens may be disposed in front of the light emitting surface of the LED; where the focusing lens is adapted to focus the light from the LED to parallel light or near-parallel light, and the light of the backlight source firstly enters the focusing lens and then enters the optical fingerprint sensor.

In some embodiments, the non-opaque substrate includes a first side surface close to the backlight source, where the light emitting from the backlight source enters the non-opaque substrate from the first side surface; an anti-reflective layer may be disposed on the first side surface, where the anti-reflective layer is adapted to increase the proportion of the light from the backlight source entering the non-opaque substrate. structure, and a filter layer may be disposed between the face of the protective layer and the upper surface of the optical fingerprint sensor.

Compared with the prior art, embodiments of the present disclosure has the following advantages:

A new optical fingerprint module is provided, wherein the optical fingerprint module includes a protective layer, a touch sensitive layer, an optical fingerprint sensor and a backlight source. The optical fingerprint sensor includes a non-opaque substrate and a device layer disposed on the surface of the non-opaque substrate, the device layer includes a pixel area, the pixel area includes a plurality of pixels, and each pixel has a light transmitting area and a light-blocked area, where the light-blocked area has a photosensitive device formed therein, and the light transmitting area allows light to pass through the pixel area of the device layer. The protective layer is disposed above the optical fingerprint sensor. The backlight source is disposed below the pixel area, and the angle between the light emitting from the backlight source and the upper surface of the protective layer is acute.

Since the backlight source is below the pixel area, the light emitting from the backlight source passes through the optical fingerprint sensor (including through the optical fingerprint sensor, and also through the non-opaque substrate, or passing through the non-opaque substrate and the pixel area), and then reaches the protective layer, and the angle between the corresponding light and the upper surface of the protective layer is acute (that is, the angle between the light and the pixel area is acute. Since all the light reaching the upper surface of the protective layer forms an acute angle with the upper surface of the protective layer, reflection occurs for all the light reaching the upper surface of the protective layer at the interface between the upper surface of the protective layer and the lower surface of fingerprint with shift distances, and most of the effective reflected light is irradiated into corresponding pixels in the pixel area at substantially the nearly same shift distances from the corresponding reflection points, so that the entire optical fingerprint module can work without a light guide plate, to form a clear fingerprint image. The structure of the optical fingerprint module is simplified, whose cost is also lower.

Further, a touch sensing layer is also provided between the protective layer and the optical fingerprint sensor, so that the optical fingerprint module also has the touch sensing function.

Further, a non opaque layer is provided between the touch sensing layer and the device layer of the optical fingerprint sensor, so as to reduce the parasitic capacitance between the touch sensing layer and the device layer to ensure that the touch sensing function and the fingerprint imaging function can both work well.

Further, the backlight source includes two LEDs. In the process of fingerprint image acquisition, either of the LED is chosen as an light source, or the two LEDs is alternately chosen as an illuminating light for the fingerprint imaging, and then a corresponding image calculation can be performed, so as to obtain a fingerprint image with less distortion and higher accuracy, and further to improve the performance of optical fingerprint module.

Further, a focusing lens is provided in front of the light emitting surface of the LED, and the focusing lens can focus the light of the backlight source into parallel light or near-parallel light. The light of the backlight source first enters the focusing lens, and then enters the optical fingerprint sensor, therefore, parallel light or near-parallel light can be used for fingerprint image acquisition, which result in less distortion and higher accuracy of the fingerprint image, and further improve the performance of optical fingerprint module.

Further, the side surface of the non-opaque substrate near the backlight source is set as a first side surface, and the light emitting from the backlight source enters the non-opaque substrate from the first side surface, wherein an anti-reflective layer is disposed on the first side surface. The light anti-reflective layer can increase the proportion of the light from the backlight source entering the non-opaque substrate. Therefore, when the fingerprint image acquisition is carried out, more light can be used for the fingerprint imaging, whereby the fingerprint image with higher signal and accuracy can be obtained, and the optical fingerprint module with further improvement in the performance can be obtained.

### BRIEF DESCRIPTION OF THE DRAWINGS

FIG. 1 is a schematic diagram of a existing optical fingerprint module;

FIG. 2 is a top view of a existing optical fingerprint sensor;

FIG. 3 is a schematic cross-sectional view of the optical fingerprint sensor shown in FIG. 2 along line A-A in FIG. 2;

FIG. 4 is an enlarged schematic view of the structure in a dashed line frame 220A enclosed in the optical fingerprint sensor shown in FIG. 2;

FIG. 5 is a schematic diagram of the cross-sectional structure of the optical fingerprint module including the optical fingerprint sensor shown in FIG. 4 along dotted line B-B in FIG. 4;

FIG. 6 is a schematic top view of an optical fingerprint sensor and a backlight source in an optical fingerprint module according to one embodiment of the present invention;

FIG. 7 is a schematic cross-sectional view of an optical fingerprint module according to one embodiment of the present invention;

FIG. 8 is an equivalent circuit diagram of a touch function in an optical fingerprint module according to one embodiment of the present invention;

FIG. 9 is a schematic cross-sectional view of an optical fingerprint module according to one embodiment of the present invention;

FIG. 10 is a schematic cross-sectional view of an optical fingerprint module according to another embodiment of the present invention;

FIG. 11 is a schematic cross-sectional view of an optical fingerprint module according to another embodiment of the present invention.

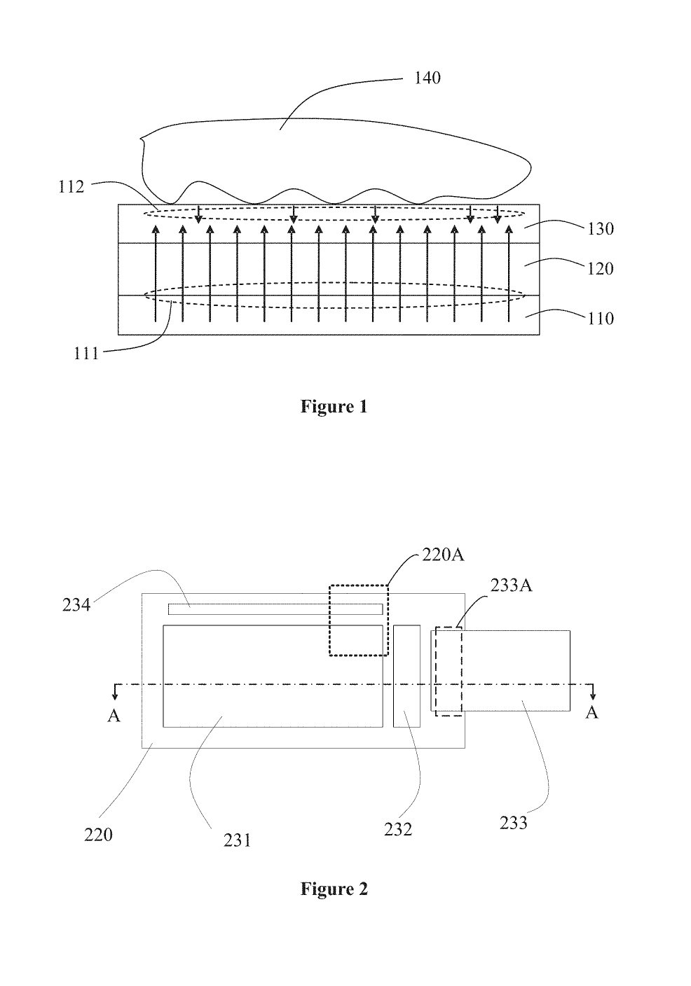

### DETAILED DESCRIPTION

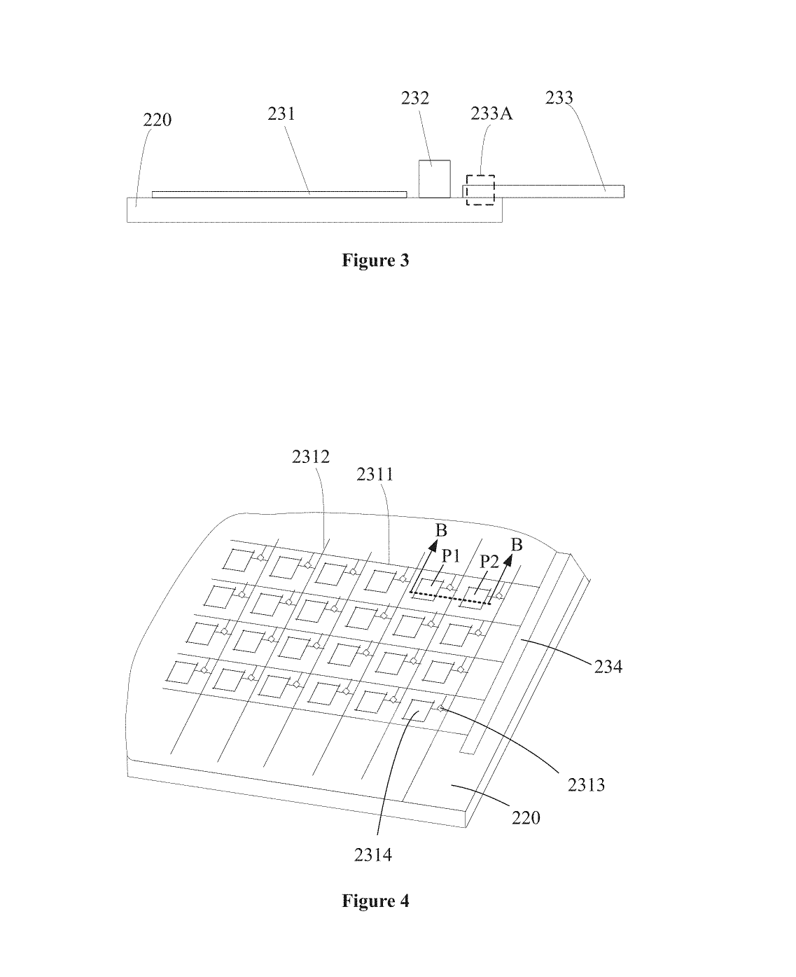

An existing optical fingerprint sensor is as shown in FIG. 2 and FIG. 3, FIG. 2 is a top view of an existing optical fingerprint sensor. FIG. 3 is a schematic cross-sectional view of the optical fingerprint sensor shown along A-A in FIG. 2. The optical fingerprint sensor includes a glass substrate 220, and a pixel array area 231 and a peripheral circuit area on the glass substrate 220. The peripheral circuit area includes a drive circuit 234, a signal readout chip 232 and a flexible printed circuit board 233, The pixel array area 231 includes a pixel array which is adapted for receiving, converting, and storing signals. The peripheral circuit area also includes connection lines among the flexible printed circuit board bonding area 233A, the pixel array area 231, the signal readout chip bonding area 232 and the bonding area of the flexible printed circuit board 233 (the connection lines are not shown in FIG. 3).

FIG. 4 is an enlarged schematic view of a structure enclosed in a dashed line frame 220A in the optical fingerprint sensor shown in FIG. 2. As shown in FIG. 4, the pixel array area 231 includes a plurality of pixels (not labeled) arranged in an array in rows, a row and a column of a pixel is defined by a plurality of first axial scanning lines 2311 and a plurality of second axial data lines 2312. Each of the plurality of pixels includes a signal control switch 2313 and a photoelectric conversion device 2314, and the pixel area further includes a light transmitting area (not labeled in FIG. 4) which is non-opaque, where the corresponding backlight can pass through the optical fingerprint sensor through the light transmitting area. The scanning line 2311 is connected with the driving circuit 234. The data line 2312 is connected with the bonding area of the signal readout chip 232.

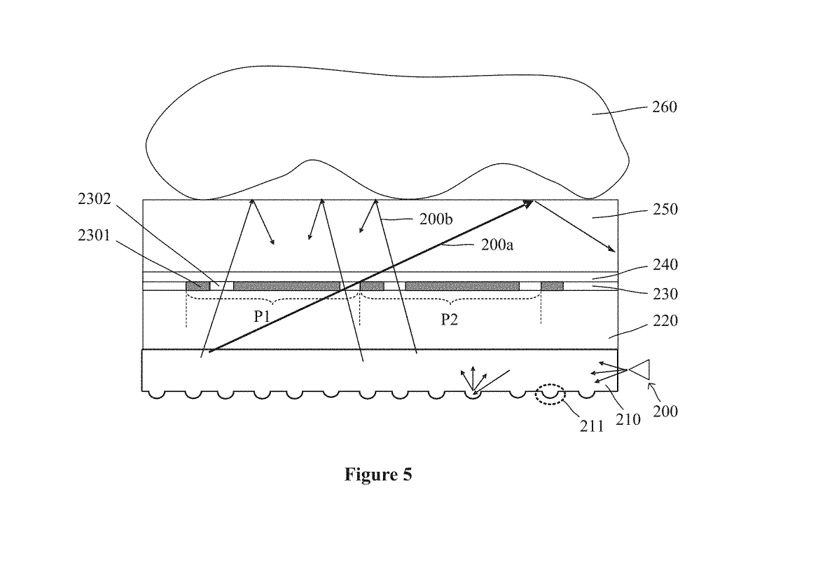

FIG. 5 is a schematic diagram of the cross-sectional structure of the optical fingerprint module including the optical fingerprint sensor shown in FIG. 4. The cross-sectional position of FIG. 5 is at a position along the B-B dotted line in the structure shown in FIG. 4, which passes through the pixel P1 and pixel P2 in FIG. 4. As shown in FIG. 5, the optical fingerprint module includes a backlight source 200, a light guide plate 210, an optical fingerprint sensor (not labeled), a glue layer 240, and a protective layer 250, the optical fingerprint sensor includes a non-opaque substrate 220, a device layer 230 on the surface of the non-opaque substrate 220, and FIG. 5 shows that both the pixel P1 and the pixel P2 includes a light-blocked area 2301 and a light transmitting area 2302.

In the existing optical fingerprint module, an LED is usually used as the backlight source 200 and is disposed on a side of the light guide plate 210, and the light emitting from the backlight source 200 irradiates into the light guide plate 210 at a certain open angle. The light guide plate 210 has a plurality of hemispherical or semi-ellipsoidal small bumps 211, and the light inside the light guide plate 210 irradiating to the small bumps 211 will be scattered, and is changed in direction upward. A reflective film (not shown in FIG. 5) is also disposed on the bottom of the light guide plate 210 (below the small bumps 211) and the other side of the light guide plate 210, most of the light reaching the bottom or the other side of the light guide plate 210 is reflected back to the light guide plate 210 to be scattered upward by the small bump 211 also.

However, since the light scattered upward from the small bump 211 disposed at the bottom of the light guide plate 210 is distributed in a certain angle range, including vertical upward, obliquely upward, or even upward close to the horizontal angle (as light 200a shown). The light 200b irradiates to the protective layer 250 at an angle nearly vertical (the “vertical” refers to the light perpendicular to the upper surface of the protective layer 250), then the light is reflected and transmitted at the contact interface of the finger 260 touching, therefore the reflected light irradiates at a nearly vertical angle to the sensor, that is, the reflected light will irradiate to the corresponding pixel or nearby pixels below. Since the light 200a deviates from vertical a large angle or even near a horizontal angle, the reflected light from the light 200a will irradiate to a pixel farther away. The signals from the light 200a and the light 200b would mix together to form a blurred fingerprint image.

Since the protective layer 250 must have a corresponding thickness to achieve certain reliability, it is almost inevitable to form a blurred fingerprint image, or even not capable of forming a valid fingerprint image from an existing optical fingerprint module.

To this end, embodiments of the present disclosure provide an optical fingerprint module, in which a backlight source is disposed below the pixel area so that the light emitting from the backlight source passes through the optical fingerprint sensor (passing through the optical fingerprint sensor includes passing through the non-opaque substrate, or passing through the non-opaque substrate and the pixel area), and then reaches the protective layer, and the angle between the corresponding light and the upper surface of the protective layer is acute. All the light reaching the upper surface of the protective layer forms an acute angle with the upper surface of the protective layer, thus, reflection occurs for all the light reaching the upper surface of the protective layer at the interface between the upper surface of the protective layer and the lower surface of fingerprint with a corresponding shift distances, and most of the effective reflected light irradiates into corresponding pixels in the pixel area at substantially the nearly same shift distances from the corresponding reflection points. Therefore, the entire optical fingerprint module can work without a light guide plate, to form a clear fingerprint image. The structure of the optical fingerprint module is simplified, whose cost is lower. Further, a touch sensing layer may be provided between the protective layer and the optical fingerprint sensor, so that the optical fingerprint module can also have a touch sensing feature.

The foregoing objects, features and advantages of the present invention will become more apparent from the following detailed description of specific embodiments of the invention taken in conjunction with the accompanying drawings.

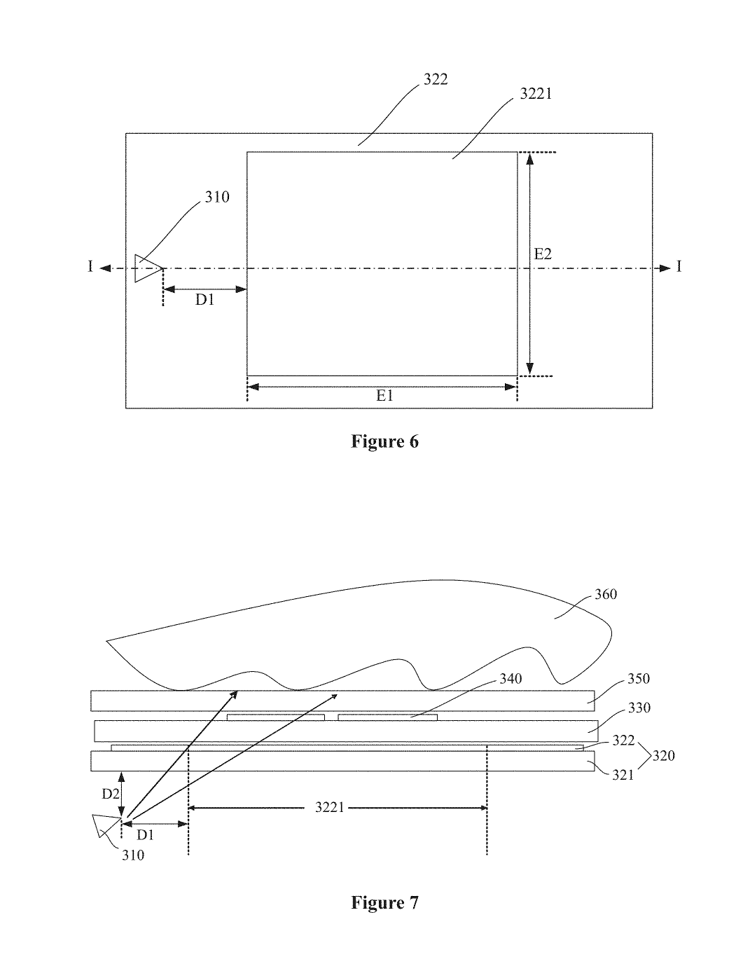

One embodiment of the present invention provides an optical fingerprint module, which is described with reference to FIGS. 6 and 7. FIG. 6 illustrates a schematic top view of a device layer 322 and a backlight source 310 of the optical fingerprint sensor 320 in the optical fingerprint module, and FIG. 7 illustrates a schematic cross-sectional view of the optical fingerprint module according to one embodiment of the present invention. It should be noted that the cross section shown in FIG. 7 is a cross section along line I-I shown in FIG. 6.

With reference to FIG. 6 and FIG. 7, the optical fingerprint module includes a backlight source 310, an optical fingerprint sensor 320, a non opaque layer 330, a touch sensing layer 340, and a protective layer 350. A finger 360 is placed on an upper surface of the protective layer 350 (the finger 360 does not belong to a part of the optical fingerprint module). The optical fingerprint sensor 320 includes a non-opaque substrate 321 and a device layer 322, and the device layer 322 is disposed on the surface of the non-opaque substrate 321. The device layer 322 includes a pixel area 3221.

The top view of the pixel area 3221 and the device layer 322 is shown in FIG. 6. In the present embodiment, the pixel area 3221 takes a rectangular shape, length of one of the side of the pixel area 3221 is E1, and length of the other neighboring side is E2, and the size of the side length E1 and the side length E2 can vary according to the product requirements. There are a plurality of pixels in the pixel area 3221 (pixels not shown in FIG. 6, the pixel-related contents can be referred to the corresponding contents of FIGS. 4 and 5). Each of the plurality of pixels includes a light transmitting area and a light-blocked area, and the light-blocked area includes a photosensitive device, and the light transmitting area is adapted to allow light passing through the pixel area 3221 of the device layer 322,

It should be noted that, in the device layer 322, other areas around the pixel area 3221 can be light transmittable, that is, the pixel area 3221 is light transmittable due to the light transmittable area of each pixel, and areas, other than pixel area 3221, the entire area or part of the area, can also be made to be light transmittable.

It should be noted that, in FIG. 7, the pixel area 3221 is marked between two long dashed lines, representing that in the plane of the cross section shown in FIG. 7, the pixel area 3221 is disposed between the two long dashed lines of the entire optical fingerprint sensor 320, for example, the optical fingerprint sensor 320 may be disposed in various layers on the area between the two dashed lines (as shown in FIG. 6, the pixel area 3221 is a part of the area of the device layer 322). And the area between the two dashed lines below the entire optical fingerprint sensor 320 is the area just below the pixel area 3221. In the corresponding schematic cross-sectional views in the other embodiments of the present specification, the above-described method is also applied to the labeling of the corresponding pixel areas, which is explained herein.

As shown in FIG. 7, the protective layer 350 is disposed above the optical fingerprint sensor 320, and the backlight source 310 is disposed below the pixel area 3221. Therefore, the angle between the light emitting from the backlight source 310 and the upper surface of the protective layer 350 is acute. Since the surface of the pixel area 3221 is generally parallel to the upper surface of the protective layer 350, the angle between the light emitting from the backlight source 310 and the surface of the pixel area 3221 is also acute.

The light emitting from the backlight source 310 is shown as a black unidirectional arrow in FIG. 7. Since the backlight source 310 is disposed obliquely below the pixel area 3221, the backlight source 310 is disposed on one side of the pixel areas 3221 in the schematic view shown in FIG. 6. In the cross-sectional view shown in FIG. 7, the area just below the pixel area 3221 is the area between the two long dashed lines, and the backlight source 310 falls outside the area. In the cross-sectional view shown in FIG. 7, there is a first distance D1 (the first distance D1 is also shown in FIG. 6) between the backlight source 310 and the area just below the pixel area 3221 in the horizontal direction; and in the vertical direction there is a second distance D2 between the backlight source 310 and the entire optical fingerprint sensor 320. Since the pixel area 3221 is part of the optical fingerprint sensor 320, the distance between the backlight source 310 and the pixel area 3221 is greater than the second distance D2 in the vertical direction.

As described above, the backlight source 310 is disposed at the lower side of the pixel area 3221 due to the first distance D1 and the second distance D2, and the lower side is a lower part of the outer of the pixel area 3221, or the lower side is an obliquely lower part. In the present embodiment, the backlight source 310 can be set at an appropriate position by adjusting the first distance D1 and the second distance D2 so as to improve the quality of the fingerprint image formed by the optical fingerprint module.

It should be noted that, in other embodiments, if the open angle of light emission of the backlight source 310 is large enough or not the entire image area is required for imaging, the backlight source 310 can be placed at the lower part of the inner side of the pixel area 3221 (or just below the pixel area 3221), that is, as shown in the top view, the backlight source 310 is disposed at the edge or interior of the pixel area 3221, where the second distance D2 is zero or negative. In other embodiments of the present disclosure, the backlight source can be placed at the lower part of the inside of the pixel area, which is explained herein.

In the present embodiment, the backlight source 310 can be an LED, and the light of the LED includes near ultraviolet light, purple light, blue light, green light, yellow light, red light, near infrared light, or white light.

It should be noted that in other embodiments, the backlight source 310 includes two or more LEDs, and the two or more LEDs can be symmetrically located evenly below the optical fingerprint sensor 320, and light emitting from each LED includes near ultraviolet light, purple light, blue light, green light, yellow light, red light, near infrared light, or white light. If the backlight source 310 includes two or more LEDs, the light of each LED can be the same or different; the lights from some LEDs are the same, the lights from some LEDs are different.

Still with reference to FIG. 7, the optical fingerprint module further includes a non opaque layer 330, and the non opaque layer 330 is disposed between the protective layer 350 and the optical fingerprint sensor 320. The optical fingerprint module also includes a touch sensing layer 340. The touch sensing layer 340 is disposed between the protective layer 350 and the non-opaque layer 330.

In the present embodiment, the touch sensing layer 340 is directly disposed on the upper surface of non-opaque layer 330. As shown in FIG. 7, there is a gap between the upper surface of the light transmission layer 330, the touch sensing layer 340 and the protective layer 350. In the actual structure, the gap can be filled with optical glue, or retained by sealing. Similarly, there is a gap between the device layer 322 and the non opaque layer 330, the gap can be filled with optical glue, or retained by sealing.

It should be noted that a plurality of first axial scanning lines 2311 and a plurality of second axial data lines can also be disposed in the device layer 322 area, the plurality of scanning lines and the plurality of data lines define a plurality of grids, the pixels are disposed in the grid, and contents of this section can be referred to the corresponding contents of FIG. 4 and FIG. 5.

In the present embodiment, the protective layer 350 includes a single layer structure, and the material includes glass or a transparent plastic.

It should be noted that, in other embodiments, the protective layer 350 can also be a multilayer structure, and a filter layer can be provided between the lower surface of the protective layer and the upper surface of the optical fingerprint sensor. The filter layer can be an interference reflection layer with a multilayer film structure. The filter layer can filter ambient light or change the appearance color of the optical fingerprint module.

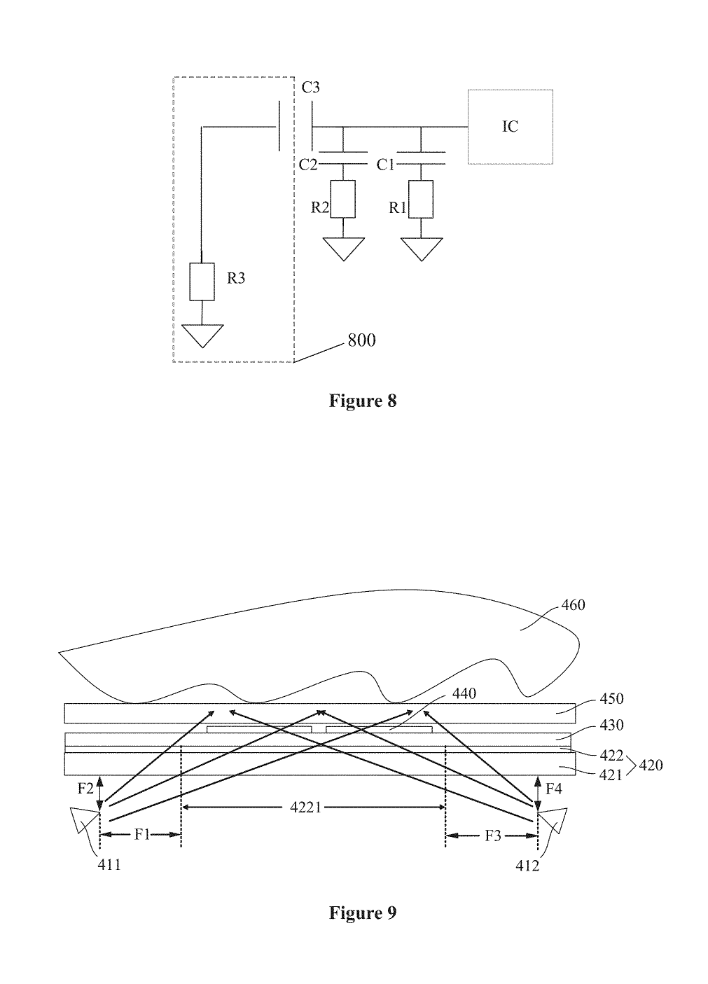

Referring to FIG. 8, an equivalent circuit diagram of a touch function in an optical fingerprint module is provided according to one embodiment of the present invention. The circuit structure surrounded by the dashed line frame 800 represents the equivalent circuit structure of a finger. The capacitance between the touch sensing layer 340 and the device layer 322 is C1, the capacitance between the different electrodes inside the touch sensing layer 340 is C2, and the capacitance between the touch sensing layer 340 and the finger 360 is C3. The equivalent resistance between the device layer 322 and the ground is R1, the equivalent resistance between the touch sensing layer 340 and the ground is R2, and the equivalent resistance between the finger 360 and the ground is R3. It should be noted that the IC shown in FIG. 8 represents a capacitive touch sensing chip, which is not shown in FIGS. 6 and 7, but the IC can be part of an optical fingerprint module or be independent of the optical fingerprint module.

In the present embodiment, the touch sensing layer 340 includes a capacitive touch sensing layer. The total capacitance of capacitive touch sensing layer and other structures should meet certain requirements, the total capacitance value cannot be too large, otherwise the IC cannot work (beyond the loading range).

In the present embodiment, the total capacitance of the touch sensing layer 340 and other structures includes C1, C2, and C3. As described above, the total capacitance value cannot be too large, but the higher the proportion of capacitor C3 to the total capacitance value, the better. Because the higher the proportion of C3, the larger the difference of signals between with fingers and without fingers, and the larger of noise-signal ratio. Therefore, the other two capacitors need to be minimized.

In the present embodiment, the touch sensing layer 340 employs a mutual capacitive touch sensing layer, where C2 is the fringe electric field capacitance, which is generally very small, and normally the effect of C2 on the total capacitance can be ignored.

In this embodiment, since the facing area between the touch sensing layer 340 and the device layer 322 is relative large, the (parasitic) capacitance C1 between the touch sensing layer 340 and the device layer 322 is large. In order to reduce the total capacitance, it is necessary to reduce the parasitic capacitance C1 to improve the noise-signal ratio.

Therefore, a non opaque layer 330 is added to reduce the parasitic capacitance between the touch sensing layer 340 and the device layer 322 of the optical fingerprint sensor 320.

In some embodiments, the value of the capacitor C1 can be controlled within a more suitable range by controlling the thickness of the non opaque layer 330. In some embodiments, the thickness of the non opaque layer 330 is less than 1.5 mm and more than 0.01 mm. The thickness of the non opaque layer 330 is controlled to be less than 1.5 mm to ensure the fingerprint image is good enough, and thickness of the non opaque layer 300 is controlled more than 0.01 mm, so as to ensure the value of the capacitor C1 being small enough.

In addition, a material with a small dielectric constant can be employed to be the non opaque layer 330 to further reduce the parasitic capacitance between the touch sensing layer 340 and the device layer 322 in the optical fingerprint sensor 320.

In the optical fingerprint module provided by the present embodiment, the blacklight source 310 is specifically disposed outside and below the pixel area 3221. so that the light emitting from the backlight source 310 passes through the optical fingerprint sensor 320 (passing through the optical fingerprint sensor 320 includes passing through the non-opaque substrate 321, also includes passing through the device layer 322), and then reach the protective layer 350, and the angle between the light and the upper surface of the protective layer 350 is acute. The light reaching the upper surface of the protective layer 350 forms an acute angle with the upper surface of the protective layer 350, therefore, reflection occurs for all the light reaching the upper surface of the protective layer 350 at the interface between the upper surface of the protective layer 350 and the lower surface of fingerprint with a corresponding shift distances, and most of the effective reflected light irradiates into corresponding pixel in the pixel area 3221 at substantially the nearly same shift distances from the corresponding reflection points. Therefore, the entire optical fingerprint module can work without a light guide plate, to form a clear fingerprint image, and to achieve fingerprint image recognition. The structure of the optical fingerprint module is simplified, and cost low. Further, according to the optical fingerprint module provided in the present embodiment, a touch sensing layer 340 may be provided between the protective layer 350 and the optical fingerprint sensor 320, so that the optical fingerprint module can also have a touch sensing function.

In the optical fingerprint module provided by the present embodiment, a non opaque layer 330 is provided between the touch sensing layer 340 and the device layer 322 to reduce the parasitic capacitance between the touch sensing layer 340 and the device layer 322. and to ensure that the sensing function and fingerprint imaging function can both work well.

One of the embodiments of the present invention provides another optical fingerprint module. Referring to FIG. 9, a schematic cross-sectional view of an optical fingerprint module is provided. The optical fingerprint module includes a backlight source (not shown), an optical fingerprint sensor 420, a non opaque layer 430, a touch sensing layer 440, and a protective layer 450. The optical fingerprint sensor 420 includes a non-opaque substrate 421 and a device layer 422 disposed on the upper surface of the non-opaque substrate 421. The device layer 422 includes a pixel area 4221. FIG. 9 also shows a finger 460 disposed above the protective layer 450 (the finger 460 does not belong to the optical fingerprint module). The optical fingerprint sensor 420, the non opaque layer 430, the touch sensing layer 440, and the protective layer 450 can be referred to the corresponding optical fingerprint sensor, the non opaque layer, the touch sensing layer, and the protective layer as described in above embodiments.

Similar to the above embodiments, in the present embodiment, the backlight source is disposed outside and below the pixel area 4221, so that the angle between the light emitting from the backlight source and the upper surface of the protective layer 450 is acute. Unlike the previous embodiment, as shown in FIG. 9. in the present embodiment, the backlight source includes two LEDs, LEDs 411 and LEDs 412, respectively. The light emitting from the LED 411 and the LED 412 are shown as black unidirectional arrows in FIG. 9. The LED 411 and the LED 412 are disposed below the outside of the pixel area 4221. In the schematic view shown in FIG. 9, the LED 411 and the LED 412 are disposed outside and below two sides of the pixel area 4221. In the cross-sectional view shown in FIG. 9, the area just below the pixel area 4221 is the area among the two long dashed lines, and the LED 411 and the LED 412 falls outside this area.

Therefore, as shown in FIG. 9, there is a first distance F1 between the LED 411 and the area just below the pixel area 4221 in the horizontal direction; and in the vertical direction, there is a second distance F2 between the LED 411 and the entire optical fingerprint sensor 420. Since the pixel area 4221 is a part of the optical fingerprint sensor 420, the distance between the LED 411 and the pixel area 4221 is larger than the second distance F2 in the vertical direction.

As can be seen from the description above, the LEI) 411 is disposed outside and below the pixel area 4221 due to the first distance F1 and the second distance F2. In the present embodiment, the LED image 411 can be disposed at an appropriate position by adjusting the first distance F1 and the second distance F2, so as to improve the quality of the fingerprint image formed by the optical fingerprint module.

Similarly, in the cross-section view shown in FIG. 9, there is a first distance F3 between the LED 412 and the area just below the pixel area 4221 in the horizontal direction; and in the vertical direction, there is a second distance F4 between the LED 412 and the entire optical fingerprint sensor 420. Since the pixel area 4221 is a part of the optical fingerprint sensor 420, the distance between the LED 412 and the pixel area 4221 should be larger than the second distance F4 in the vertical direction. As can be seen from the description above, the LED 412 should be disposed outside and below the pixel area 4221 due to the first distance F3 and the second distance F4. In the present embodiment, the LED 412 can be disposed at an appropriate position by adjusting the first distance F3 and the second distance F4, so that the quality of the fingerprint image formed by the optical fingerprint module can be improved.

It should be noted that if the backlight source includes two or more LEDs (for example, the LED 411 and the LED 412 in the present embodiment), the shortest distance to the pixel area 4221 of all LEDs can be set as the distance between the backlight source and the pixel area 4221.

In the present embodiment, the light emitting from the LED 411 and the LED 412 includes near ultraviolet light, purple light, blue light, green light, yellow light, red light, near infrared light, or white light. Also, the lights emitting from the two LEDs can be the same or different. It should be noted that in other embodiments, the backlight source can include three or more LEDs, and the three or more LEDs can be symmetrically and evenly distributed below the optical fingerprint sensor 420, In some embodiments, when the backlight source includes four LEDs, the four LEDs can be symmetrically distributed below the four sides of the rectangular pixel area 4221 when the top view of the pixel area 421 is rectangular. In other embodiments, the light of each LED includes near ultraviolet light, purple light, blue light, green light, yellow light, red light, near infrared light, or white light, the light of each LED can be the same, or also can be different, or the lights from some LEDs are same, and the lights from some LEDs are different.

In the optical fingerprint module provided by the present embodiment, the entire optical fingerprint module can work without a light guide plate, to form a clear fingerprint image, and to achieve fingerprint image recognition. The structure of the optical fingerprint module is simplified, and lower cost. In addition, the backlight source can include the LED 411 and the LED 412, the light of any one of the LEDs can be selected as the imaging light source for the fingerprint imaging.

In addition, since the emergent light of the LED 411 and the LED 412 has a certain open angle range but not in parallel, the incident angle of the light reaching the different area of the upper surface of the protective layer 450 is slightly different. Therefore, the shift distance between corresponding reflected points and the pixel irradiated by the light at the different locations of upper surface of the protective layer 450, varies slightly, therefore slight image distortion may be produced. The thicker the protective layer 450, the larger the distortion. Therefore, in the present embodiment, either of the LED is chosen as the imaging light source, or the two LEDs is alternately chosen as the light source and then a image calculation is performed, so as to obtain a fingerprint image with less distortion and higher accuracy, and further to improve the performance of optical fingerprint module.

In other embodiments, if the backlight source includes more LEDs, it is also possible to perform the imaging with each LED alternately on, and then perform noise reduction and compensation calculation to obtain fingerprint image with a better quality and higher accuracy, to further improve the performance of optical fingerprint module.

More descriptions on the structure, properties and advantages of the optical fingerprint module provided in this embodiment can be referred to the corresponding contents of the above embodiments.

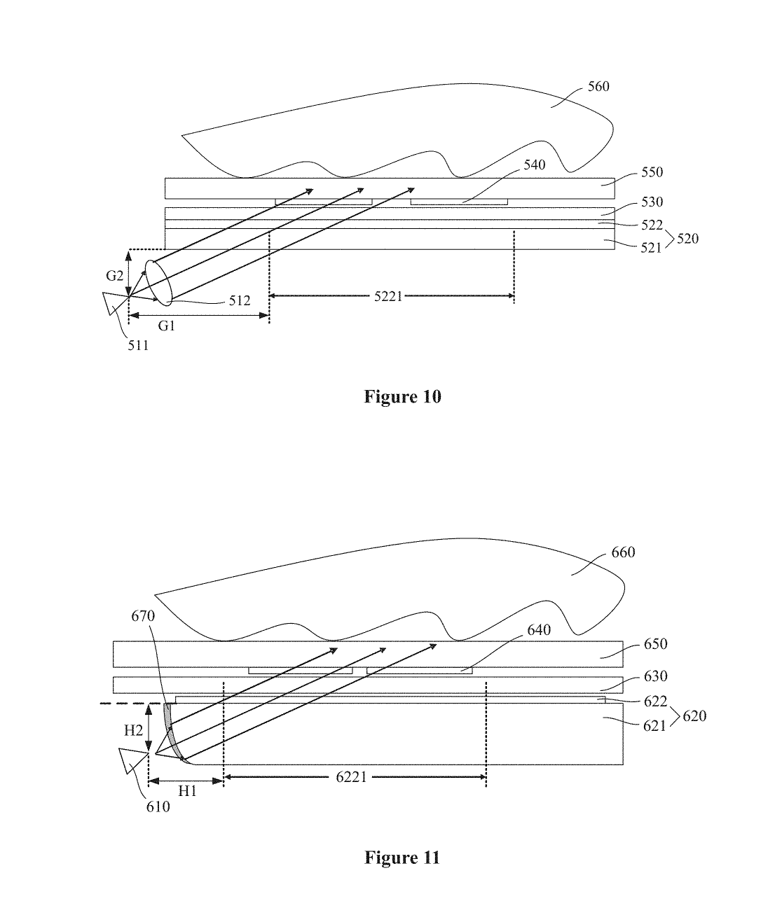

In some embodiments, another optical fingerprint module, referring to FIG. 10, is provided. FIG. 10 is a schematic cross-sectional view of an optical fingerprint module. The optical fingerprint module includes a protective layer 550, an optical fingerprint sensor 520, a backlight source 511, a non opaque layer 530, and a touch sensing layer 540. The optical fingerprint sensor 520 includes a non opaque substrate 521 and a device layer 522 disposed on the upper surface of the non opaque substrate 521. The device layer 522 includes a pixel area 5221. FIG. 10 also shows a finger 560 placed above the protective layer 550 (the finger 560 is not a part of the optical fingerprint module). Wherein, the protective layer 550 and the optical fingerprint sensor 520 can refer to the corresponding contents of the non opaque layer, the touch sensitive layer, the protective layer, and the optical fingerprint sensor as described in above embodiments.

In the present embodiment, the non-opaque layer 530 includes a glass layer, a plastic layer, or an optical adhesive layer. The optical adhesive layer includes a heat curing adhesive layer, a light curing adhesive layer, or an optical double-sided tape.

In the present embodiment, the light emitting from the backlight source 511 is indicated by a unidirectional arrow in FIG. 10. Since the backlight source 511 is disposed obliquely below the pixel area 5221, the backlight source 511 is disposed on one side of the pixel area 5221 as shown in the FIG. 10. And as shown in FIG. 10, the area just below the pixel area 5221 is between the two long dashed lines, and the backlight source 511 falls outside the area. Therefore, there is a first distance G1 between the backlight source 511 and the area just below the pixel area 5221 in the horizontal direction, and in the vertical direction, there is a second distance G2. between the backlight source 511 and the entire optical fingerprint sensor 520. Since the pixel area 5221 is a part of the optical fingerprint sensor 520, the distance between the backlight source 511 and the pixel area 5221 is larger than the second distance G2 in the vertical direction.

As described above, the backlight source 511 is disposed below the pixel area 5221 due to the first distance G1 and the second distance G2, and it is easy to understand that it is outside of and under the pixel area 5221. In the present embodiment, the backlight source 511 can be disposed at an appropriate position by adjusting the first distance G1 and the second distance G2 so as to improve the quality of the fingerprint image formed by the optical fingerprint module.

Different from the previous embodiment, in front of the light emitting surface of the backlight source 511, a focusing lens 512 is disposed, and the focusing lens 512 is adapted to focus the light of the backlight source 511 into parallel light or nearly parallel light, and the light emitting from the backlight source 511 first enters the focusing lens 512 and then enters the optical fingerprint sensor 520.

In some embodiments, the focusing lens 512 can be a convex lens, and the light passing through the focusing lens 512 can be focused to be parallel light if the distance between the backlight source 511 and the focusing lens 512 is equal to the focal length of the convex lens. In some embodiments, the focusing lens 512 can also be other suitable lenses, such as a Fresnel lens.

In the optical fingerprint module provided by the present embodiment, the entire optical fingerprint module can work without a light guide plate, to achieve fingerprint image recognition, and to form a clear fingerprint image. The structure of the optical fingerprint module is simplified, and lower cost. Further, a focusing lens 512 is provided in front of the light emitting surface of the backlight source 511. The focusing lens 512 can focus the light of the backlight source 511 into parallel light or near-parallel light. The light from the backlight source 511 first enters the focusing lens 512 and then enters the optical fingerprint sensor 520, therefore it is possible to acquire a fingerprint image by using parallel light or near-parallel light, therefore, a fingerprint image with less distortion and a higher accuracy can be obtained, which further improves the optical fingerprint module performance.

Further descriptions on the structure, properties and advantages of the optical fingerprint module of this embodiment can be referred to the corresponding contents of the foregoing embodiment.

The present disclosure further provides another optical fingerprint module. Referring to FIG. 11, FIG. 11 is a schematic cross-sectional view of the optical fingerprint module including a protective layer 650, an optical fingerprint sensor 620, a backlight source 610, a non opaque layer 630, and a touch sensing layer 640. The optical fingerprint sensor 620 includes a non-opaque substrate 621 and a device layer 622. on the upper surface of the non-opaque substrate 621. The device layer 622 includes a pixel area 6221. FIG. 11 also shows a finger 660 (finger 660 does not belong to the optical fingerprint module) placed above the protective layer 650. The non opaque layer 630, the touch sensing layer 640, the protective layer 650, and the optical fingerprint sensor 620 can refer to the corresponding contents of the non-opaque layer, the touch sensitive layer, the protective layer, and the optical fingerprint sensor as described in above embodiments.

In the present embodiment, the touch sensing layer 640 is directly disposed on the lower surface of the protective layer 650. With this, the touch sensing layer 640 is closer to the finger 660; therefore the sensitivity of the touch function can be further improved. Also, the non opaque layer 630 can be a glass layer, a plastic layer, or an optical adhesive layer. The optical adhesive layer can include a heat curing adhesive layer, a light curing adhesive layer, or an optical double-sided tape.

In the present embodiment, the light emitting from the backlight source 610 is indicated by a unidirectional arrow in FIG. 11. Since the backlight source 610 is disposed obliquely below the pixel area 6221, the backlight source 610 is disposed on one side of the pixel areas 6221, as shown in FIG. 11. And the area just below the pixel area 6221 is the area between the two long dashed lines, and the backlight source 610 falls outside the area. Therefore, there is a first distance HI between the backlight source 610 and the area just below the pixel area 6221 in the horizontal direction, and in the vertical direction, there is a second distance H2 between the backlight source 610 and the upper surface of the non-opaque substrate 621 (i.e., the lower surface of the device layer 622). Since the pixel area 6221 is a part of the optical fingerprint sensor 620, the distance between the backlight source 610 and the pixel area 6221 is greater than the second distance H2 in the vertical direction.

As described above, the backlight source 610 is disposed below the pixel area 6221 due to the first distance H1 and the second distance H2, and it is easy to understand that it is outside of and under the pixel area 5221. In the present embodiment, the backlight source image 610 can be positioned at an appropriate position by adjusting the first distance H1 and the second distance H2 to improve the quality of the fingerprint image formed by the optical fingerprint module.

As shown in FIG. 11, in the present embodiment, the side surface of non-opaque substrate 621 close to the backlight source 610 is a first side surface not labeled). In the present embodiment, the first side is a light focusing surface, and the light emitting from the backlight source 610 enters the non-opaque substrate 621 from the light focusing surface, and the light focusing surface focuses the light emitting from the backlight source 610 into parallel light or near-parallel light.

In the present embodiment, the light-focusing surface includes an ellipsoid crown, a slope, a ball crown, a conical, or a pyramid surface.

As shown in FIG. 11, the first side is further provided with an anti-reflective layer 670. If light emitting from the backlight source enters the optical fingerprint sensor from the first side, the light first enters anti-reflective layer 670, and the anti-reflective layer 670 can increase the proportion of light from the backlight source entering the non-opaque substrate.

In the optical fingerprint module provided by the present embodiment, the non-opaque substrate 621 is adjusted as that the side surface (i.e., the first side surface) close to the backlight source 610 is a light-focusing surface, and the light-focusing surface is adapted to focus the light from the backlight source 610 into parallel or near-parallel, the light from the backlight source 610 firstly enters the non-opaque substrate 621 and then passes through the device layer 622. Therefore, during the fingerprint imaging, the fingerprint image can be acquired by using parallel light or near-parallel light with less distortion and higher accuracy, which further improves the performance of optical fingerprint module.

In addition, the anti-reflective layer 670 provided on the first side of the non-opaque substrate 621can also increase the proportion of the light from the backlight source 610 entering the non-opaque substrate 621, therefore, during the process of fingerprint imaging, the fingerprint image can be captured with more light to be higher quality and accuracy, and the performance of the optical fingerprint module can be further improved.

Further description on the structure, properties and advantages of the optical fingerprint module provided in this embodiment can be referred to the corresponding contents of above embodiments.

Although the present invention is disclosed as above, the present invention is not limited thereto. It should be understood by those skilled in the art that various changes and modifications can he made therein without departing from the spirit and scope of the invention, and that the scope of the invention is defined by the scope of the claims.

What is claimed is:

1. An optical fingerprint module, comprising:
an optical fingerprint sensor comprising a non-opaque substrate and a device layer disposed on the surface of the non-opaque substrate, wherein the device layer comprises a pixel area, the pixel area comprises a plurality of pixels, each of the pixels comprises a light transmitting area and a light-blocked area, and the light-blocked area comprises a photosensitive device, and the light-transmitting area allows lights to pass through the pixel area of the device layer;
a protective layer disposed above the optical fingerprint sensor;
a backlight source disposed below the optical fingerprint sensor, where an angle between the light emitting from the backlight source and the surface of the pixel area is acute;
a touch sensing layer disposed between the protective layer and the optical fingerprint sensor.

2. The optical fingerprint module according to claim 1, further comprising a non opaque layer between the protective layer and the optical fingerprint sensor; where the touch sensing layer is disposed between the protective layer and the optical fingerprint sensor.

3. The optical fingerprint module according to claim 2, wherein the touch sensing layer is disposed below a lower surface of the protective layer.

4. The optical fingerprint module according to claim 3, wherein the non opaque layer comprises a glass layer, a plastic layer, or an optical adhesive layer.

5. The optical fingerprint module according to claim 2, wherein the touch sensing layer is disposed above an upper surface of the non opaque layer.

6. The optical fingerprint module according to claim 2, wherein the thickness of the non opaque layer is less than 1.5 mm, and the thickness of the non-opaque layer is more than 0.01 mm.

7. The optical fingerprint module according to claim 1, wherein the backlight source comprises at least one LED, the light of the LED comprises near ultraviolet light, violet light, blue light, green Light, yellow light, red light, near infrared light, or white lights.

8. The optical fingerprint module according to claim 1, wherein a focusing lens is disposed in front of a light emitting surface of the LED;
where the focusing lens is adapted to focus the light from the LED to parallel light or near-parallel light, and the light of the backlight source firstly enters the focusing lens and then enters the optical fingerprint sensor.

9. The optical fingerprint module according to claim 1, wherein the non-opaque substrate comprises a first side surface close to the backlight source, where the light emitting from the backlight source enters the non-opaque substrate from the first side surface; an anti-reflective layer is disposed on the first side surface, where the anti-reflective layer is adapted to increase the proportion of the light of backlight source from the backlight source entering the non-opaque substrate.

10. The optical fingerprint module according to claaim 1, wherein the protective layer is a single layer or a multilayer structure, and a filter layer is disposed between the lower surface of the protective layer and the upper surface of the optical fingerprint sensor.

11. The optical fingerprint module according to claim 1, wherein the backlight source comprises two or more LEDs symmetrically distributed below the optical fingerprint sensor, the light of the LED comprises near ultraviolet light, purple light, blue light, green light, yellow light, red light, near infrared light, or white light.
